(19) United States
(12) Patent Application Publication
(10) Pub. No.: US 2024/0399726 A1
(43) Pub. Date: Dec. 5, 2024

(54) LAMINATE FOR A CARDLIKE DATA MEDIUM, CARDLIKE DATA MEDIUM AND METHOD

(71) Applicant: GIESECKE+DEVRIENT EPAYMENTS GMBH, Munchen (DE)

(72) Inventors: Josef RIEDL, Attenkirchen (DE); Peter TARANTINO, Munchen (DE)

(21) Appl. No.: 18/696,410

(22) PCT Filed: Sep. 28, 2022
(86) PCT No.: PCT/EP2022/025447

§ 371 Date: Mar. 28, 2024

(30) Foreign Application Priority Data
Sep. 29, 2021 (DE) 10 2021 004 909.8

(51) Int. Cl. B32B 27/20; B32B 27/08; B32B 27/36

(52) U.S. Cl. CPC B32B 27/20; B32B 27/08; B32B 27/36; B32B 2250/03; B32B 2250/244; B32B 2250/40; B32B 2307/20; B32B 2425/00

(57) ABSTRACT

A laminate for a cardlike data medium, includes at least three layers with a first layer, a second layer and a third layer. The second layer is disposed between the first layer and the third layer. The first layer and the third layer include polylactide, PLA, and the second layer comprises a PLA-free laser polymer mixture. The laser polymer mixture includes at least one first plastic, at least one second plastic and at least one laser additive, where a material of the first plastic is different from a material of the second plastic.

### BACKGROUND

The present invention relates to a laminate for a cardlike data medium and also to a cardlike data medium and to a method for producing a laminate for a cardlike data medium.

The prior art has disclosed various data media, examples being cardlike data media, more particularly credit cards, smart cards, dual-interface cards, or else identification documents, such as identity passes, for example. It is additionally known practice for this purpose to provide a laminate made up of multiple stacked layers in which, for example, electrical and/or electronic components may be installed or which serve as an overlay, more particularly as transparent or printed design layers. The layers are preferably layers of plastic and may be produced by means of an extrusion method. The layers may subsequently be printed and joined to one another by lamination, via pressure and heat, to give a card body for the cardlike data medium.

It is known practice to produce such data media or cards in general from thermoplastic materials such as polyvinyl chloride (PVC) and polyethylene terephthalate (PET). In recent years, however, an increasing environmental awareness has steered attention toward the usage of biodegradable plastics. For example, polylactide (PLA), commonly called polylactic acid, is increasingly being used. PLA can be deformed by supply of heat and is therefore also a thermoplastic material. Advantageously, polylactide plastics are biocompatible and therefore environmentally benign.

A disadvantage which has emerged when using PLA, however, is that printing a PLA layer or a PLA film by means of a laser presents problems and therefore a PLA layer or a PLA film has only little laser-based processability and printability. The reason for this is that plastics of this kind are unable to absorb virtually any laser radiation in the region of near ultraviolet to near infrared light. The personalizing or printing of a cardlike data medium by means of a laser with a PLA layer or PLA film present is therefore more difficult or not possible.

### SUMMARY

It is an object of the present invention to specify a laminate for a cardlike data medium, especially for a smart card, where laser personalization can be enabled and improved for the eco-friendly use of PLA layers. It is a further object of the present invention to specify such a cardlike data medium and a method for producing a laminate.

Configurations and developments of the invention are specified in the dependent claims and disclosed with reference to the description and the figures. Features and details that are described in connection with the laminate of the invention are also valid in connection with the cardlike data medium of the invention and with the method of the invention, and vice versa, and so cross-reference may always be made in respect of the disclosure in relation to the individual aspects of the invention.

Provided according to a first aspect of the invention is a laminate for a cardlike data medium, more particularly a smart card, the laminate comprising at least three layers, with a first layer, a second layer and a third layer, where the second layer is disposed between the first layer and the third layer, where the first layer and the third layer comprise polylactide, PLA, and the second layer comprises a PLA-free laser polymer mixture, where the laser polymer mixture includes at least a first plastic, at least a second plastic and at least one laser additive, where a material of the first plastic is different from a material of the second plastic. Envisaged in other words are two PLA layers, more particularly transparent PLA layers, where a layer, more particularly a transparent layer, with the laser polymer mixture is arranged between the PLA layers. The laser polymer mixture here includes at least three materials, more particularly a first and a second plastic and a laser additive. The PLA for the first layer and for the third layer is preferably extremely amorphous, so as to ensure better integration for the laminate.

In the context of the specification, the laminate comprises at least three layers. Illustratively, all three layers are configured transparently for printing. In particular, a multiplicity of layers may be envisaged. The layers are preferably disposed parallel to one another and stacked one atop another. In other words, the layers in the laminate lie on one another.

In the context of the specification, cardlike data elements preferably comprise smart cards, where the laminate may serve as an overlay. It should be stated, however, that the invention may be transposed to a wide variety of different card types according to requirement.

The invention has the advantage that the use of PLA layers is very environmentally benign. Additionally, the laser additive of the laser polymer mixture allows for reliable, high-contrast printing and hence personalization of the overall laminate. On contact with laser radiation, the laser additive in the laser polymer mixture provides for the laser energy to be converted into fusion heat, and so the laser additive, owing to a local change in the refractive index, may appear colored in grayscale stages from white to black and may exhibit high contrast as printing. In other words, the laser additive can be used to guarantee improved definition and contrast and also an extended life and increased resistance to environmental factors affecting the printing. In particular, through the use of the laser additive, the laser polymer mixture can be laser-sensitized, so to speak, and so made processable and printable by the laser. The laser additive here may permit printing preferably for nontransparent or transparent layers. Illustratively, the laser-sensitized laser polymer mixture may be disposed as a second layer between the transparent first PLA layer and the transparent third PLA layer. Via the use of a laser for printing the laser polymer mixture, it is additionally possible, generally, to enable high depth of penetration of the laser radiation into the laser polymer mixture, so making the printing both wear-resistant and forgeryproof. All in all, laser printing represents a rapid, flexible and precise printing technique by comparison with conventional printing methods. To summarize, therefore, an eco-friendly, laser-printable, PLA-comprising laminate can be provided in a simple way.

The first plastic may preferably be polycarbonate, PC. The use of polycarbonate has the advantage that polycarbonate can be printed/processed very effectively with a laser. Through the use of polycarbonate, therefore, the printability of the laminate may be further improved additionally to the use of the laser additive. In the context of the specific creation, it is also possible, illustratively, for the first layer as polycarbonate to be formed of a mixture of different polycarbonates having different melt viscosities.

The laser polymer mixture preferably includes a weight fraction of the first plastic of at least 50% and at most 85%. Illustratively, therefore, the laser polymer mixture may include between a 50% weight fraction and an 85% weight fraction of polycarbonate. Polycarbonate may therefore constitute the main constituent of the laser polymer mixture.

In one preferred embodiment, the second plastic may be polyethylene terephthalate-glycol copolymer, PETG. The use of PETG in the laser polymer mixture has the advantage that the extrusion temperature of PETG is approximately 230° C., the extrusion temperature of PLA likewise being approximately 230° C. The extrusion temperature of the laser polymer mixture may therefore be approximated to the extrusion temperature of PLA through the use of PETG and coextrusion of the laminate can be simplified and improved.

The laser polymer mixture may preferably include a weight fraction of the second plastic of at least 15% and at most 50%. Illustratively, therefore, the laser polymer mixture may include between a 15% weight fraction and a 50% weight fraction of PETG. PETG may therefore constitute the secondary constituent of the laser polymer mixture.

The laser additive may preferably be formed by a material which absorbs in the infrared region, more particularly in the near infrared region. The laser additive may more particularly take the form of pellets, the pellets being formed by the material which absorbs in the infrared region. In other words, the laser additive is formed preferably by a multiplicity of particles. The laser additive may preferably be distributed homogeneously in the laser polymer mixture or within the second layer. This has the advantage that the printing is unified and the contrast can be increased. Consequently, extremely high resolutions and definitions can be realized for the printing. For example, the use of different laser additives in the laser polymer mixture may also be envisaged. The laser additive may preferably be formed by nanoscale metal oxide particles which on account of their low particle size do not scatter visible light but are able to absorb the wavelength of the laser in the infrared region, more particularly in the near infrared region, and so to enable printing. When, for example, a laser beam impinges on a metal oxide particle, the laser energy is absorbed by the metal oxide particle and the immediate vicinity becomes heated. This may result in a locally confined change in the refractive index, with the respective metal oxide particle appearing in grayscale stages from white to black and therefore representing printing, according to the first plastic and second plastic materials present in the laser polymer mixture and to the choice of the laser wavelength. Alternatively, it is also conceivable for the laser additive to be formed by a material which absorbs in the ultraviolet region, more particularly in the near ultraviolet region. In the ultraviolet region, in analogy to the infrared region, printing may also be enabled by means of a laser additive. As a result, UV lasers as well may be used for the printing. Printing by means of a CO₂ laser would also be conceivable.

In one preferred embodiment it may be the case that wavelengths of at least 760 nm and at most 2500 nm, preferably 1064 nm, are absorbable by means of the absorbing material of the laser additive. In other words, by means of the absorbing material, wavelengths of a laser in the near infrared region may be absorbed. With preference a wavelength of 1064 nm is absorbed. This wavelength is assigned illustratively to an Nd:YAG laser (short for neodymium-doped yttrium aluminum garnet laser or neodymium-YAG laser), which is a frequently employed solid-state laser.

With particular preference it may be the case that the laser additive is formed by titanium nitride, TiN, a tungsten oxide compound, a molybdenum oxide compound, more particularly copper molybdenum oxide, a copper oxide compound, more particularly copper phosphate oxide, or carbon black pigments or is formed as an encapsulated laser additive. There are, generally, other kinds of materials conceivable that exhibit the property of absorbing laser light having a particular wavelength and hence of enabling printing. It is generally conceivable here that metallic particles may be used for the laser additive. In the context of the specification, an encapsulated laser additive refers to an embodiment of the laser additive as a multiplicity of microcapsules, which include the active substance for blackening or for printing in the interior of the respective capsule. When, for example, laser light impinges on a capsule, the capsule can be destroyed and the active substance in the interior can be activated for blackening or for printing.

The laser polymer mixture may preferably include a weight fraction of the laser additive of at least 0.0005% and at most 5%. In particular, the weight fraction of the laser additive may preferably be 5 ppm (parts per million). The weight fraction of the laser additive may be varied here preferably depending on the desired contrast level of the printing. Illustratively, therefore, the laser polymer mixture may include between a 0.0005% weight fraction and a 5% weight fraction of laser additive. The laser additive may therefore constitute the least constituent of the laser polymer mixture.

Illustratively, therefore, a laser polymer mixture would be conceivable that includes as first plastic polycarbonate with a weight fraction of 84%, as second plastic PETG with a weight fraction of 15%, and a laser additive with a weight fraction of 1%. The percentages for the weight fraction for the first plastic, the second plastic and the laser additive may be selected variably from the specified ranges for the weight fraction in such a way as to make the sum total 100%.

In one preferred embodiment, an extrusion temperature of the first plastic and/or an extrusion temperature of the second plastic may be substantially the same, more particularly within a deviation of at most 10%, as an extrusion temperature of PLA. Illustratively, PETG as second plastic has an extrusion temperature of approximately 230° C., with the extrusion temperature of PLA likewise being approximately 230° C. PC, conversely, has an extrusion temperature of approximately 300° C. When using PC and PETG for the laser polymer mixture, therefore, it is possible through a suitable mixture of PC and PETG to approximate the overall extrusion temperature of the laser polymer mixture, through the use of PETG, to the extrusion temperature of PLA and to simplify and improve coextrusion of the laminate.

Provided according to a second aspect of the invention is a cardlike data medium, more particularly a smart card, which comprises a laminate of the invention. The cardlike data medium of the invention consequently has the same advantages as have been elucidated in relation to the laminate of the invention.

Provided according to a third aspect of the invention is a method for producing a laminate for a cardlike data medium of the invention, more particularly for a smart card, where the method includes the following steps:
providing polylactide, PLA, for the first layer and the third layer in a main extruder of an extrusion apparatus;
providing the PLA-free laser polymer mixture for the second layer in a secondary extruder of the extrusion apparatus;
coextruding the PLA and the PLA-free laser polymer mixture to give a laminate.

In particular, the PLA for the first layer and for the third layer may be provided as pellets for the main extruder. The laser polymer mixture for the second layer may be provided, illustratively, also as pellets for the secondary extruder. With coextrusion, different materials can be conveyed through the same extrusion apparatus. Here, the different materials can be united to give a specific laminate through the use of main extruder and secondary extruder. In the extrusion apparatus, for example, the PLA pellets may be melted in the main extruder and the pellets of the laser polymer mixture in the secondary extruder, and the layers of the laminate may be united and formed. Ideally, the extrusion temperature of the PLA and the extrusion temperature of the laser polymer mixture here are approximately the same, so that the materials have a similar viscosity. This allows a stable bond for the laminate to be ensured. The use of coextrusion in comparison to lamination has the advantage that the entire material is melted and is available for integration, whereas in the case of lamination under pressure and heat, material is available for integration only at the boundary faces of the layers. Consequently, the durability of the laminate can be boosted as a result of coextrusion. After the production of the laminate, the cardlike data medium may additionally be produced by lamination of the laminate as an overlay film to further core films.

Overall, the method of the invention has the same advantages as elucidated in relation to the laminate of the invention.

With preference, the providing of the PLA-free laser polymer mixture comprises premixing the first plastic, the second plastic and the laser additive. In this case, preferably, the laser additive may be distributed homogeneously in the laser polymer mixture. Alternatively, the first plastic, the second plastic and the laser additive for the laser polymer mixture may be provided individually in succession in the secondary extruder.

### BRIEF DESCRIPTION OF THE DRAWINGS

The present invention is described illustratively below, with reference to the appended figures, in the context of embodiments. It will be appreciated that individual features of the embodiments, in so far as is technically reasonable, may be freely combined with one another without leaving the scope of the present invention. Elements having the same function and mode of action are given the same reference signs in the figures. In the figures below,

FIG. 1 shows a cross-sectional view of a laminate according to one exemplary embodiment of the invention; and

FIG. 2 shows a schematic view of a method of the invention for producing a laminate of the invention.

### DETAILED DESCRIPTION OF VARIOUS EMBODIMENTS

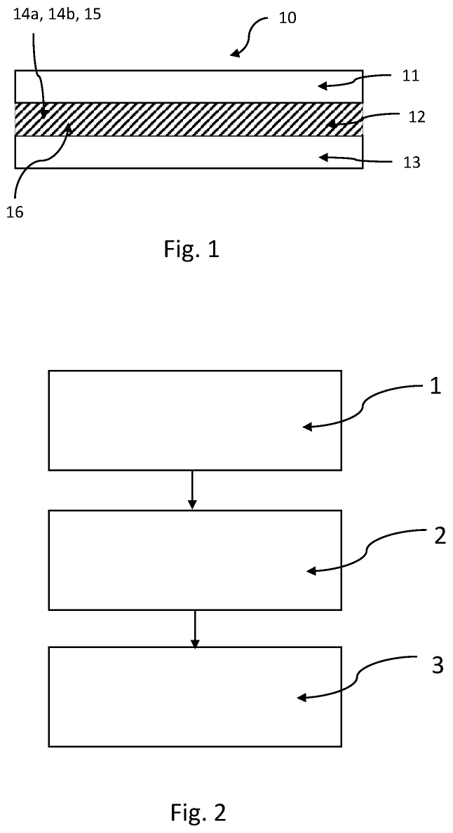

FIG. 1 shows a cross-sectional view of a laminate 10 according to one exemplary embodiment of the invention. The laminate 10 is suitable for a cardlike data medium, more particularly for a smart card. The laminate 10 may for example form an overlay film for the smart card.

The laminate 10 comprises three layers 11, 12, 13, with a first layer 11, a second layer 12 and a third layer 13, where the second layer 12 is disposed between the first layer 11 and the third layer 13. Illustratively, the first layer 11, the second layer 12 and the third layer 13 are configured transparently.

The first layer 11 and the third layer 13 comprise polylactide, PLA. In other words, the first layer 11 and the third layer 13 are formed of PLA. An eco-friendly, PLA-comprising laminate 10 for the cardlike data medium can therefore be provided.

The second layer 12 comprises a PLA-free laser polymer mixture 16. In other words, the second layer 12 is formed of the laser polymer mixture 16. The laser polymer mixture 16 includes a first plastic 14a, a second plastic 14b and a laser additive 15. The first plastic 14a, illustratively, is polycarbonate, PC. In particular, the laser polymer mixture 16 includes a weight fraction of the first plastic 14a of at least 50% and at most 85%. Additionally and illustratively, the second plastic 14b is polyethylene terephthalate-glycol copolymer, PETG. The material of the first plastic 14a is therefore different from the material of the second plastic 14b. In particular, the laser polymer mixture 16 includes a weight fraction of the second plastic 14b of at least 15% and at most 50%.

Additionally, the laser additive 15 is formed by a material which absorbs in the infrared region, more particularly in the near infrared region. By means of the absorbing material of the laser additive 15, preferably, a wavelength of 1064 nm, from an Nd: YAG laser, for example, may be absorbed. The laser additive 15 may be formed, for example, by copper molybdenum oxide. In particular, the laser polymer mixture 16 includes a weight fraction of the laser additive 15 of at least 0.0005% and at most 5%.

The use of PETG in the laser polymer mixture 16 has the advantage that the extrusion temperature of PETG is approximately 230° C., with the extrusion temperature of PLA being likewise approximately 230° C. In other words, the extrusion temperature of the second plastic 14b is the same as the extrusion temperature of PLA. Through the use of PETG, therefore, the extrusion temperature of the laser polymer mixture 16 can be approximated to the extrusion temperature of PLA and coextrusion of the laminate 10 can be simplified and improved.

All in all, the use of PLA layers for the laminate 10 is very environmentally benign. Additionally, the laser additive 15 of the laser polymer mixture 16 makes it possible to enable reliable, high-contrast printing and hence personalization of the overall laminate 10. The use of polycarbonate for the first plastic 14a has the advantage that polycarbonate can be processed/printed very effectively with a laser. Through the use of polycarbonate, therefore, it is possible to achieve a further improvement in the printability of the laminate 10 in addition to the use of the laser additive 15. To summarize, therefore, an eco-friendly, laser-printable, PLA-comprising laminate 10 can be provided in a simple way.

FIG. 2 shows a schematic view of a method of the invention for producing a laminate 10 of the invention. In particular, a laminate 10 according to FIG. 1 can be produced. The method includes the following method steps:

In a first step 1, polylactide, PLA, for the first layer 11 and the third layer 13 is provided in a main extruder of an exclusion apparatus. The PLA here may be provided preferably as pellets. In a second step 2, the PLA-free laser polymer mixture 16 for the second layer 12 is provided in a secondary extruder of the extrusion apparatus. The laser polymer mixture 16 here may preferably also be provided as pellets. Here, the sequence of steps 1 and 2 may be varied. In a third step 3, the PLA and the PLA-free laser polymer mixture 16 are co-extruded to give a laminate 10. With the coextrusion, different materials can be conveyed through the same extrusion apparatus. In the extrusion apparatus, for example, the PLA pellets may be melted in the main extruder and the pellets of the laser polymer mixture 16 in the secondary extruder, and the layers of the laminate 10 can be united and formed. Illustratively, the extrusion temperature of the PLA and the extrusion temperature of the laser polymer mixture 16 are approximately the same, through the use of PETG as second plastic 14b, so that the viscosity of the materials is similar. Therefore, a stable bond for the laminate 10 can be ensured.

The providing of the PLA-free laser polymer mixture 16 in the second method step 2 may preferably comprise premixing the first plastic 14a, the second plastic 14b and the laser additive 15.

After the production of the laminate 10, the cardlike data medium may be additionally produced by lamination of the laminate 10 as overlay film to further core films.

1.-13. (canceled)

14. A laminate for a cardlike data medium, comprising at least three layers, with a first layer, a second layer and a third layer, where the second layer is disposed between the first layer and the third layer, where the first layer and the third layer comprise polylactide, PLA, and the second layer comprises a PLA-free laser polymer mixture, where the laser polymer mixture includes at least a first plastic, at least a second plastic and at least one laser additive, where a material of the first plastic is different from a material of the second plastic.

15. The laminate according to claim 14, wherein the first plastic is polycarbonate, PC.

16. The laminate according to claim 14, wherein the laser polymer mixture includes a weight fraction of the first plastic of at least 50% and at most 85%.

17. The laminate according to claim 14, wherein the second plastic is polyethylene terephthalate-glycol copolymer, PETG.

18. The laminate according to claim 14, wherein the laser polymer mixture includes a weight fraction of the second plastic of at least 15% and at most 50%.

19. The laminate according to claim 14, wherein the laser additive is formed by a material which absorbs in the infrared region, or in the near infrared region.

20. The laminate according to claim 19, wherein wavelengths of at least 760 nm and at most 2500 nm, are absorbable by means of the absorbing material of the laser additive.

21. The laminate according to claim 14, wherein the laser additive is formed by titanium nitride, TiN, a tungsten oxide compound, a molybdenum oxide compound, or carbon black pigments or is formed as an encapsulated laser additive.

22. The laminate according to claim 14, wherein the laser polymer mixture includes a weight fraction of the laser additive of at least 0.0005% and at most 5%.

23. The laminate according to claim 14, wherein an extrusion temperature of the first plastic and/or an extrusion temperature of the second plastic is substantially the same as an extrusion temperature of PLA.

24. A cardlike data medium, comprising a laminate according to claim 14.

25. A method for producing a laminate for a cardlike data medium, according to claim 14, where the method includes the following steps:
providing polylactide, PLA, for the first layer and the third layer in a main extruder of an extrusion apparatus;
providing the PLA-free laser polymer mixture for the second layer in a secondary extruder of the extrusion apparatus;
coextruding the PLA and the PLA-free laser polymer mixture to give a laminate.

26. The method according to claim 25, wherein the providing of the PLA-free laser polymer mixture comprises premixing the first plastic, the second plastic and the laser additive.
